(19) United States
(12) Patent Application Publication
(10) Pub. No.: US 2026/0192192 A1
(43) Pub. Date: Jul. 9, 2026

(54) Handheld Game Controller with a Second Screen Experience

(71) Applicant: Backbone Labs, Inc., Beaverton, OR (US)

(72) Inventors: Maneet Khaira, Vancouver, WA (US); Shawn O’Connor, Portland, OR (US); Andrew Sibert, Santa Cruz, CA (US); Timothy Aldridge, Seattle, WA (US); Joshua Donlan, Oviedo, FL (US); Rohan Kapur, San Francisco, CA (US)

(73) Assignee: Backbone Labs, Inc., Beaverton, OR (US)

(21) Appl. No.: 19/013,753

(22) Filed: Jan. 8, 2025

(51) Int. Cl. A63F 13/26; A63F 13/24

(52) U.S. Cl. CPC A63F 13/26; A63F 13/24

(57) ABSTRACT

A handheld game controller with a second screen experience is presented. Various embodiments described herein relate to solutions to the problems of: hardware limited controller-specific inputs and outputs, a lack of built-in Bluetooth or Wi-Fi in mobile game controllers, difficulty connecting to TV streaming devices that do not support Bluetooth or Wi-Fi, friction and discoverability around pairing, and a lack of access to game companion app integration. Other embodiments are provided, and each of the embodiments can be used alone or in combination.

### BACKGROUND

A game controller is a device used to provide input to a video game, for example, to control an object or character in the video game. Some game controllers have user input devices and functionality that are designed for a specific game console. For example, a PlayStation game console uses a PlayStation game controller, which has different user input devices and functionality than an Xbox game controller. Several attempts have been made to provide a game controller that is compatible with different types of game consoles, and, more generally, to create a more seamless, user-friendly, and universally-compatible gaming experience, despite gaps in integration generally around hardware features, connectivity standards and/or app ecosystems. For example, multi-platform or modular game controllers are available, but such game controllers may lack desired features and have not gained widespread adoption. Other attempts include the use of game controller remapping software, companion apps, voice chat workarounds, adapters/dongles, and cloud gaming services.

### BRIEF DESCRIPTION OF THE DRAWINGS

FIG. 1A-1D are example architectures of embodiments.

FIG. 2 is a screen shot of a second screen experience mode of an embodiment.

FIG. 3 is a flow chart of a method of an embodiment for entering a second screen experience mode.

FIG. 4 is a screen shot of control widgets of an embodiment.

FIG. 5 is a screen shot of additional widgets of an embodiment.

FIG. 6 is a diagram illustrating a haptic feedback embodiment.

FIG. 7 is a screen shot for a profile management embodiment.

FIG. 8A is a diagram illustrating a platform operating system embodiment.

FIG. 8B is a process flow diagram of an embodiment.

FIG. 9 is a diagram illustrating a Bluetooth relay mechanism of an embodiment.

FIG. 10 is a process flow diagram of an embodiment.

FIG. 11 is a screen shot showing an example guided pairing and single one-click connection of an embodiment.

FIG. 12 is a screen shot of an embodiment showing active and previously-connected devices.

FIGS. 13 and 14 are screen shots of an embodiment showing a second screen experience handling multiple pairings and profiles.

FIG. 15 is a screen shot showing unique gameplay and apps in a second screen experience.

FIG. 16 is an illustration of a game controller of an embodiment.

FIG. 17 is an illustration of the game controller of FIG. 16 in which handles of the game controller are extended to accept a mobile computing device between the handles.

FIG. 18 is an illustration of the game controller of FIG. 16 in which the handles of the game controller are retracted to secure the mobile computing device between the handles.

FIGS. 19A-19D are illustrations of a foldable game controller of an embodiment.

FIGS. 20A-20C are illustrations of a game controller of an embodiment without movable handles.

### DETAILED DESCRIPTION

### Overview of Attempts to Create a “Universal” Game Controller

As mentioned above, several attempts have been made to provide a game controller that is compatible with different types of game consoles, and, more generally, to create a more seamless, user-friendly, and universally-compatible gaming experience, despite gaps in integration generally around hardware features, connectivity standards and/or app ecosystems. These attempts include:

### Multi-Platform Game Controllers

Some manufacturers have developed game controllers designed to work across multiple platforms. For example, the 8BitDo Pro 2 controller is compatible with Switch, PC, Android, and iOS devices. These game controllers aim to provide a more-universal experience but may still lack certain platform-specific features. For example, if a user is playing PlayStation (PS) Remote Play using an 8BitDo Pro controller, the user cannot utilize the touchpad interaction that is commonly used in PlayStation games since the hardware lacks specific controls to do so. Also, certain versions of these game controllers do not use the appropriate Bluetooth profiling to work with all available game systems in a universal manner. In other versions of these game controllers, there are physical switches on the game controller to enable a user to switch between different profiles so that they can connect to multiple types of devices (e.g., PCs, mobile devices, etc.).

### Modular Game Controllers

Some manufacturers have experimented with modular game controller designs that allow users to add or remove features as needed with physical hardware. Such game controllers have not gained widespread adoption.

### Game Controller Remapping Software

Programs, such as Steam Input and DS4Windows, allow users to remap game controller buttons and emulate different game controller types. This can help overcome some input limitations when using game controllers on non-native platforms.

### Companion Apps

Some game developers have created companion apps that can run on mobile devices alongside the main game, providing controls or features in addition to those provided on user input devices on the game controller itself. However, the integration of these apps with gameplay or the game controller itself is often limited and using the companion app on a mobile device simultaneously with a game controller can be unwieldy.

### Voice Chat Workarounds

For voice chat issues, some users have resorted to using separate third-party voice chat applications on their phones or computers (e.g., Discord) while gaming with a game controller if the game controller does not support the voice chat functionality intended for the game. Again, simultaneously using several devices (e.g. a mobile device/PC and the gaming controller) can be unwieldy.

### Adapters and Dongles

Some companies have produced adapters that allow game controllers from one platform to work on another to aid in compatibility but require an additional bespoke device (e.g., an adapter or a dongle) that can be unwieldy and inconvenient.

### Cloud Gaming Services

Platforms, such as Google Stadia (now discontinued) and NVIDIA GeForce Now, have attempted to standardize the game controller experience across devices, but these solutions are limited to their specific ecosystems. For example, Google Stadia connects over Wi-Fi directly to Google's cloud services but cannot work over Wi-Fi with, for example, Xbox Cloud Gaming. Doing so would require it to be paired with Bluetooth to the device running Xbox Cloud Gaming (e.g., an iPad or PC) or require a physical cable connection.

In summary, despite the attempts discussed above, no single comprehensive solution has emerged. The lack of standardization across gaming platforms and the rapid evolution of gaming technology continue to pose challenges in creating a universal game controller that provides a seamless, full-featured experience across all platforms and games. The following embodiments can be used to overcome at least some of these challenges.

### Second Screen Experience Overview

By way of overview, the following embodiments describe an environment in which a mobile computing device (e.g., a mobile phone, a tablet, a watch, etc.) is used to provide a “second screen experience” for a user of a game controller. The phrase “second screen” refers to the display screen of the mobile computing device, whereas the “first screen” is the display device (e.g., a television or monitor) used to display parts of, or all, the game. In this and other examples provided herein, a game console is the host device that provides the game. However, it should be understood that the game can be provided on another type of computing device, such as, but not limited to, a computer, a server, a server cluster, or another mobile computing device. So, a particular type of game host should not be read into the claims unless expressly recited therein.

In one example, the game controller is not specifically made for use with the game console (e.g., the game controller may be a third-party game controller intended for use with at least one other type of game console). As such, the game controller may not have certain user input device(s) (e.g., certain buttons, a touchpad, etc.) or certain functionality (e.g., haptics) that a game controller specifically made for use with the game console has. In another example, the game controller is specifically made for use with the game console but is less feature-rich than other game controllers specifically made for use with the game console (e.g., the game controller may be an entry-level game controller that has fewer features than an upgraded game controller).

In one embodiment, to compensate for the lack of features in the game controller, a mobile computing device is used in conjunction with the game controller to provide at least some of the functionality that the game controller is lacking (and optionally can provide additional functionality). In one example implementation, the mobile computing device comprises one or more processors and one or more non-transitory computer-readable media having program instructions stored therein that, when executed by the one or more processors, cause the one or more processors to implement a “second screen experience” app that includes at least some of the functionality described herein. (The second screen experience app can be part of a game controller app that the mobile computing device runs to interact with the game controller in other ways.) Unlike prior “companion apps” mentioned above, the second screen app of these embodiments are integrated, physically, as well as through the software, with the functionality of the game and/or game controller, thereby providing a better solution.

Before turning to a description of example functionality of the second screen experience app, the following section provides some example configurations of the game controller and mobile computing device.

### Example Configurations

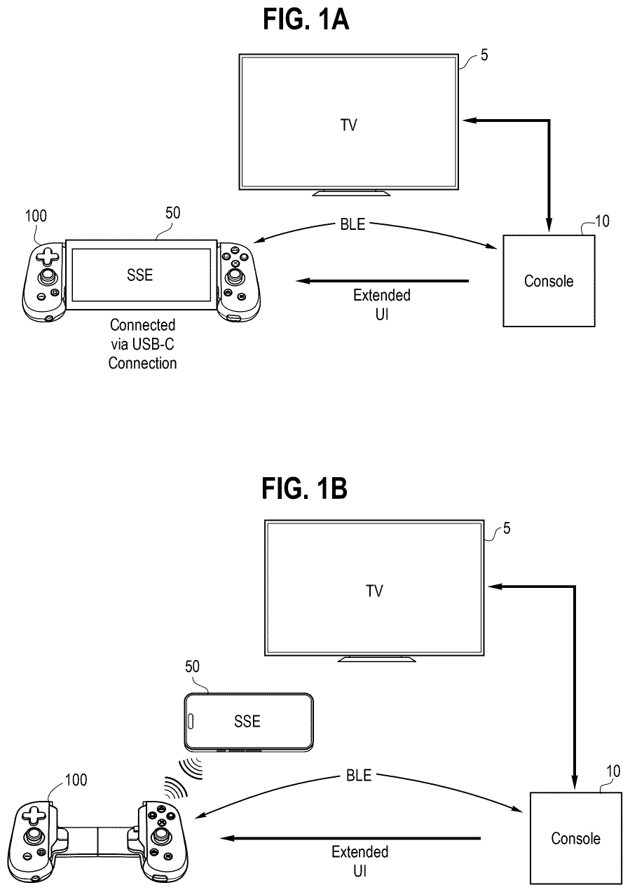

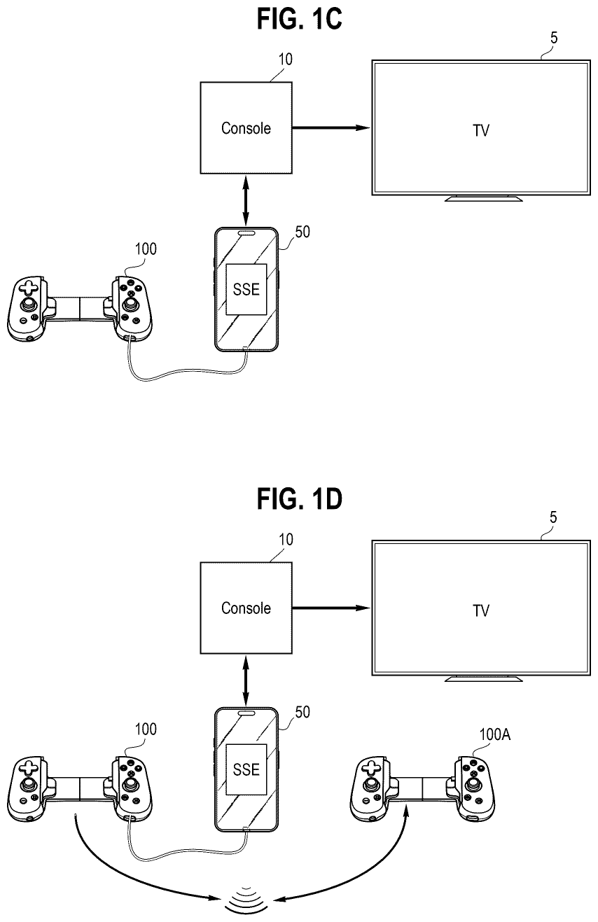

Turning now to the drawings, FIGS. 1A-1D are illustrations of example configurations showing how a game controller can be used with a mobile computing device to provide a second screen experience. It should be understood that the configurations shown in FIGS. 1A-1D are merely examples and that other configurations can be used.

In FIG. 1A, a game controller 100 wirelessly communicates (e.g., using Bluetooth Low Energy (BLE) technology, the Bluetooth relay option described below, or any other suitable technology, such as, but not limited to, Bluetooth classic, Wi-Fi, or other suitable protocols) signals to the game console 10 that are representative of user inputs received by the game controller 100 to play a game. The game console 10 communicates with a display device 5 (e.g., television or monitor) to display the game to the user of the game controller 100. As mentioned above, while a game console 10 is used in this example, other types of computing devices can be used to provide the game. Also, instead of or in addition to using a wireless connection, the game controller 100 can use a wired connection to the game console 10.

In the embodiment shown in FIG. 1A, the game controller 100 is configured to couple (e.g., mechanically and/or magnetically) with a mobile computing device 50 (here, a mobile phone), such that the game controller 100 and mobile computing device 50 are movable together and act as one integrated unit. Here, the mobile device 50 is secured between the handles of the game controller 100 (more information about this and other example game controllers are provided at the end of this document). This provides the advantage of locating the mobile computing device 50 within reach of the user's fingers while the user is holding the game controller 100. For example, the user may be able to use his thumb to touch a user input element displayed on the screen of the mobile computing device 50 while playing a game, so the user can interact with the mobile computing device 50 without letting go of the game controller 100.

In other embodiments, the game controller 100 and the mobile device 50 are coupled together in a different manner. For example, in the embodiment shown in FIG. 1B., the mobile computing device 50 is physically separated from the game controller 100 but wirelessly communicates with the game controller 100. In this embodiment, the game controller 100 may optionally not have the capability of physically retaining the mobile computing device 50 (i.e., the game controller can be designed like a traditional console-based game controller).

In another embodiment (see FIG. 1C), the mobile computing device 50 is physically separated from the game controller 100 in the sense that the game controller 100 and mobile computing device 50 are not entirely movable together and do not act as one integrated unit. However, in this embodiment, a wired connection couples the game controller 100 and mobile computing device 50 to provide electronic communication between those two components. FIG. 1D shows a variation of the embodiment of FIG. 1C, in which a second game controller 100A wirelessly connects with the game controller 100, and the mobile computing device 50 is used to provide a two-player game experience.

### Example Problems and Solutions

Connectivity and integration challenges can arise, particularly in the context of gaming hardware and software. In general, these challenges revolve around creating seamless, user-friendly, and universally-compatible gaming experiences and illustrate how gaps in integration—whether in hardware features, connectivity standards, or app ecosystems—can lead to friction, reducing the flexibility and enjoyment of modern gaming setups and reducing user performance.

The problems can relate to, including but not limited to: (1) hardware limited controller-specific inputs and outputs, (2) a lack of built-in Bluetooth or Wi-Fi in mobile game controllers, (3) difficulty connecting to TV streaming devices that do not support Bluetooth or Wi-Fi, (4) friction and discoverability around pairing, and (5) a lack of access to game companion app integration. Problems 1, 2, and 3 highlight difficulties caused by hardware limitations that restrict functionality and flexibility in gaming. The lack of universal connectivity or compatibility can hinder seamless user experiences across platforms and devices. Problems 1 and 5 also bring to light the concerns with missing game controller inputs (e.g., haptics or touchpads) or disconnected companion apps. The user experience can suffer when systems are not designed to work cohesively. Problems 4 and 5 also speak to user friction during setup or use. For instance, Problem 4 illustrates the confusion and hassle of pairing devices, compounded by non-standardized protocols, whereas Problem 5 highlights the effort required to integrate supplementary tools, such as companion apps.

The following sections describe various example solutions to one or more of these potential problems. It should be noted that a given game controller may not encounter all of these problems, and the issues described here are examples of potential challenges that may arise. Additionally, other solutions or approaches, as understood by a person of ordinary skill in the field based upon the disclosure herein, may be applicable to address these or similar issues. As such, these example problems and solutions should not be read into the claims unless expressly recited therein.

### Problem 1: Hardware Limited Controller-Specific Inputs and Outputs

Using a Bluetooth (or some other specific wireless communication technology) game controller with a gaming device allows users to play wirelessly on systems like PCs and consoles, giving the flexibility to use their preferred game controller. However, compatibility issues can arise, as not all game controllers support every input or output specific to a game or gaming platform. This can result in a subpar experience or limited access to certain game or platform features. For instance, game controllers may lack critical inputs for certain games, such as touchpad controls or haptic feedback (if the game controller does not have built-in haptic motors). Other limitations may also affect gameplay depending on the controller's design.

Additionally, users may miss out on certain features when using a game controller that is not specifically designed for their gaming device, such as using a Google Stadia Controller on a PC. The lack of certain functionality on the game controller might necessitate the use of extra accessories to achieve a complete gaming experience. For example, a user might be unable to use voice chat with a game controller while playing over Steam without a compatible headset.

To address this multi-platform compatibility problem, in one embodiment, when the game controller is connected over BLE (Bluetooth Low Energy) or another suitable wireless communication technology to a host gaming device (e.g., a PC, console, or other host gaming device), an application (app) running on the mobile computing device (or another suitable device, e.g. tablet or laptop) automatically enters into “Second Screen Experience” mode, surfacing to the user relevant controls (e.g., in a widget-based format) that are contextually determined by the device the user is connected to. Other embodiments can include other connection methods to a gaming device, such as connecting over Wi-Fi. Additional embodiments can include other apps running on gaming devices, such as PCs, while the game controller is connected.

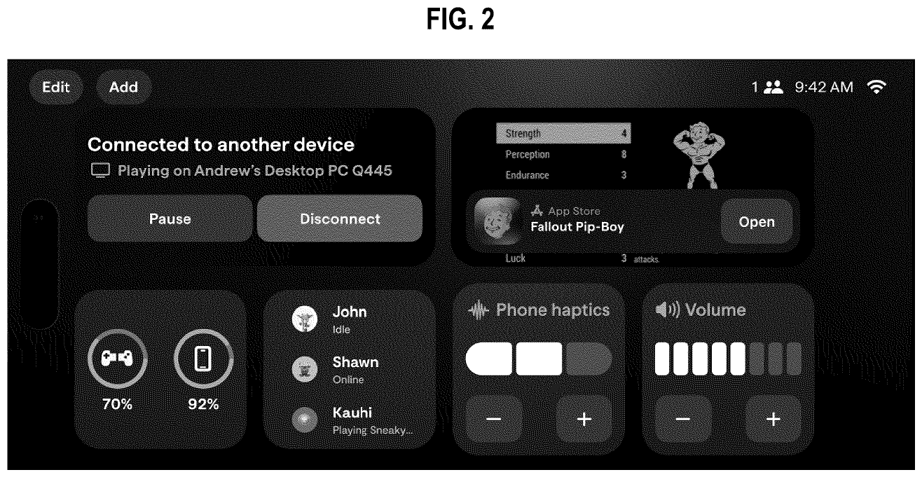

Particularly, when the mobile computing device is data-exchanged connected to the game controller (e.g., when the mobile computing device is placed in wired or wireless communication with game controller to be able to send/receive game data or other data) and the second screen experience application has been launched and running (foreground/background) on the mobile computing device, the application can detect that the mobile game controller itself is paired to an external device (such as a console or PC over BLE), the mobile computing device can prompt the application to launch the Second Screen Experience (SSE) Mode. The SSE Mode's user interface can initiate over the current screen and may offer the user a handful of options. FIG. 2 shows an example screenshot of the SSE Mode displaying a variety of widgets for phone settings (e.g., volume, haptics, battery information) and allows the user to have access to features built for the game the user is playing.

The SSE Mode acts as sort of an overlay so that a user can swipe optionally between the mode (and access widgets) or do other things on the phone (e.g., take a call or check email). For example, SSE Mode can remain active in the background when the user actions other tools on the phone, allowing the user to quickly return to the SSE Mode when the user is finished with the additional task.

Additionally, the SSE mode can leverage the mobile device to extend the game controller's interface, providing additional inputs and outputs specific to the connected gaming device. For instance, users can utilize touchpad controls or experience haptic feedback even if the game controller itself lacks these features. Additionally, SSE mode can provide the user with new additional gameplay features such as a game's “inventory management” (see, e.g., FIG. 2) or any other information panel and optional configurations a game provides.

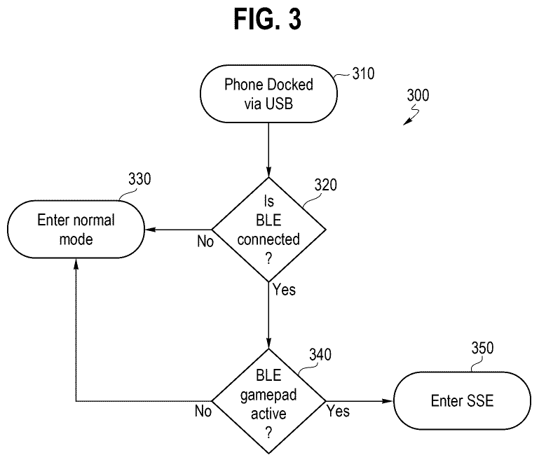

FIG. 3 is a flow chart 300 of a method of an embodiment for entering the SSE Mode. As shown in FIG. 3, after the phone is docked to the game controller (e.g., via USB-C connector) (310), the software on the phone identifies if the game controller is BLE connected (320). If the game controller is not BLE connected, the phone enters normal mode (300). However, if the game controller is BLE connected, the phone determines if BLE gamepad is active (340). If the BLE gamepad is not active, the phone enters normal mode (300). However, if the BLE gamepad is active, the phone enters the SSE mode (350).

When the mobile device is docked on the game controller (e.g., data exchanged connected), the firmware on the game controller can ping the application to check the mobile device for a simultaneous BLE connection. (The game controller can comprise one or more processors and one or more non-transitory computer-readable media having program instructions stored therein that, when executed by the one or more processors, cause the one or more processors to provide at least some of the functionality described herein that is attributable to the game controller.)

If the mobile device is connected to a “first screen” (e.g., console, TV) through BLE (or other suitable protocol), the mobile device attached to the game controller is eligible for an SSE, and the app can automatically launch the “overlay” window that offers the SSE (see FIG. 2) on the mobile device. A user can swipe this away if the user is not interested or would like to take other action on their phone, or they can let it sit on the home screen of the mobile device while they use the mobile controller. The app, through the firmware, can identify the specific gaming device (e.g., PC, console) that the game controller is connected to and determine the requisite inputs and outputs for optimal gameplay on that specific device (e.g., optimal volume or haptics, third screen experience). The app can leverage these by accessing presets through either a games database (or, more generally, data structure) or manual preferences.

In SSE Mode, when the mobile device is running the aforementioned “app” with SSE capabilities, the mobile device running the application can provide access to the following features that were otherwise not afforded in prior solutions or standard configurations:

### Widget-Based Interface:

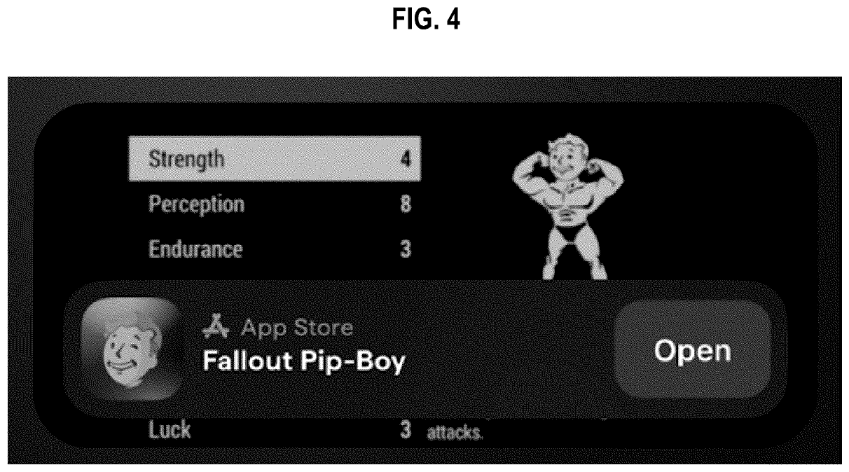

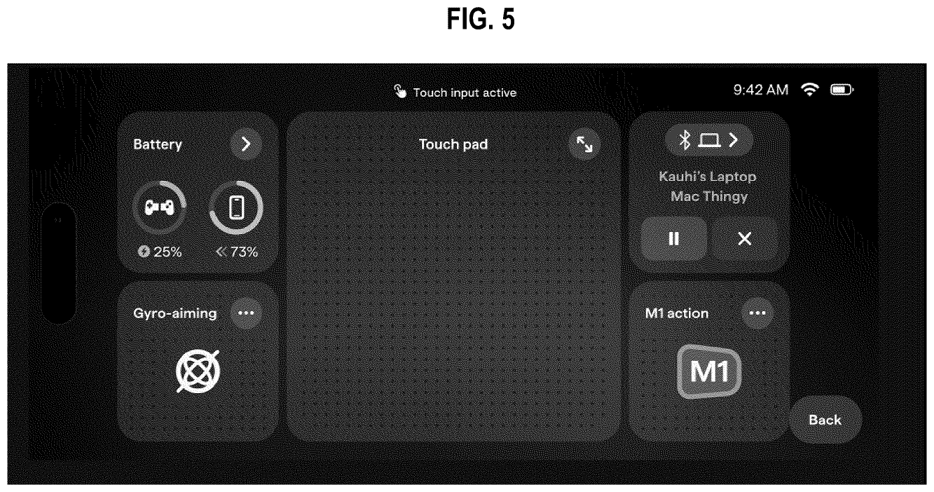

Contextual Widgets: The app surfaces relevant control widgets on the mobile device's screen based on the detected gaming device and the game being played (see, e.g., FIG. 4). Additional widgets can include touchpad controls, additional buttons, or sliders for fine-tuned control of volume, haptics, button sensitivity, or brightness of the host device (see, e.g., FIG. 5).

Dynamic Adjustment: The interface dynamically adjusts to the needs of the game, providing the user with the necessary or desired controls that are otherwise missing on the physical game controller. The application can detect the game being played on the external device (e.g., console or PC) and then render appropriate widgets and settings by pulling that information (or configuration) from a platform operation service. Certain information (e.g., optimal haptics or volume levels) may be programmed manually, or a default setting may be chosen for all games, or game specific customized settings can be used.

### Extended Inputs and Outputs:

Touchpad Controls: The smartphone screen can emulate a touchpad, allowing users to perform actions that require touch input, which is particularly useful for games on platforms such as PlayStation.

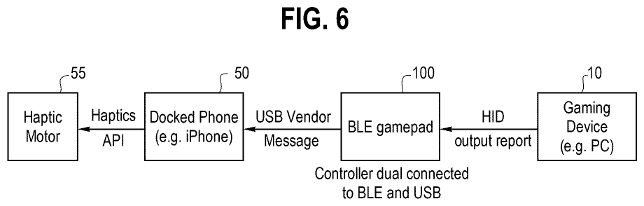

Haptic Feedback: The app can provide haptic feedback through the smartphone, simulating the vibration effects that are common in many games but might be missing from a physical game controller. The diagram in FIG. 6 illustrates this embodiment. As shown in FIG. 6, a gaming device (e.g., a PC) 10 provides a human interface device (HID) output report to the game controller 100. The game controller 100 provides a USB vendor message to the docked phone 50, which provides a haptics application programming interface (API) to a haptic motor 55 in the phone 50.

### Integration and Synchronization:

Real-Time Sync: The app can work to better ensure that the inputs from the smartphone are synchronized in real-time with the actions on the gaming device, providing a seamless and responsive gaming experience.

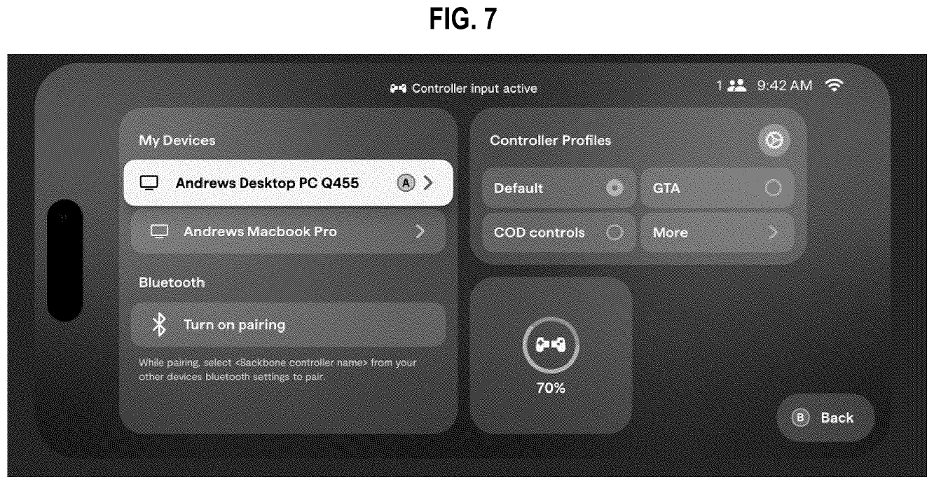

Profile Management: Users can create and manage profiles for different games and platforms, ensuring that the appropriate controls are always available (see, e.g., FIG. 7)

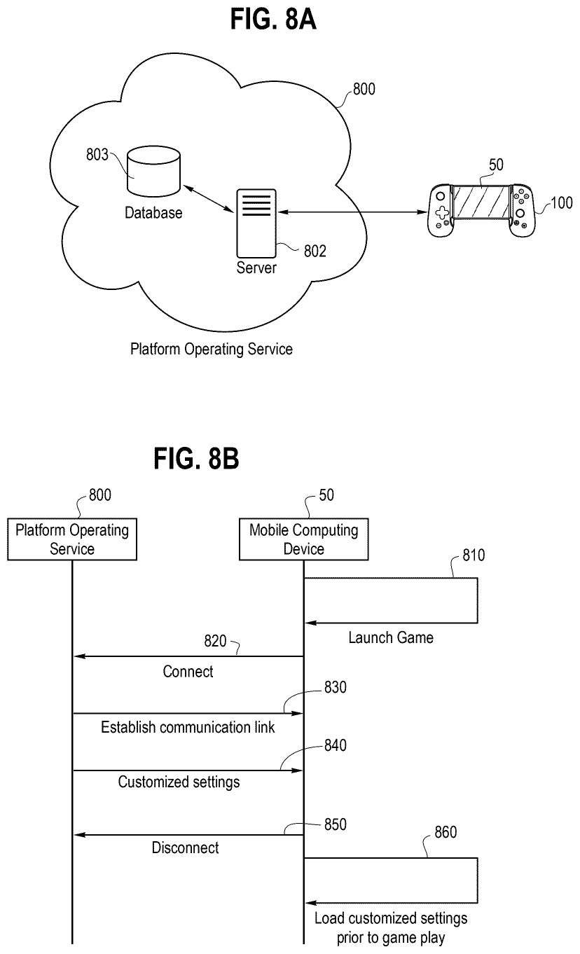

Users can save various settings on the application for various games. For example, a user might save specific button mappings for a first-person shooter game that may not apply in a racing game. Phone settings could also differ (e.g. phone haptics may be set to different levels for different events, a user could configure the app to prioritize a specific game widget when there are several available, etc.). Preferences can be saved directly on the game controller or stored in the application. In another embodiment, when a user launches that game through the game launcher functionality in the application, the application is notified to pull customized settings from a platform operating service in the cloud (or the phone) and loads them prior to gameplay. FIGS. 8A and 8B illustrate this embodiment.

FIG. 8A shows a platform operating service 800 in communication with the game controller 100 and mobile computing device 50. In this example, the platform operating service 800 comprises a server 802 and a database 803, which can store the customized settings. More information about example implementations of the platform operating service can be found in U.S. patent application Ser. No. 18/214,949, which is hereby incorporated by reference.

As shown in the process flow diagram in FIG. 8B, after a game is launched (810), the mobile computing device 50 connects to the platform operating system 800 (820). After establishing a communication link (830), the platform operating system 800 provides the customized settings stored in the database 803 to the mobile computing device 50 (840) and then disconnects (850). The customized settings are then loaded in the mobile computing device 50 prior to game play (860).

### Problem 2: Lack of Built-in Bluetooth or Wi-fi in Mobile Gaming Controllers

Some game controllers lack built-in Bluetooth or Wi-Fi connectivity capability, which limits their ability to connect wirelessly to gaming systems (e.g. console or PC). This forces users to rely on wired connections, reducing the convenience and flexibility of wireless play. In some embodiments, the SSE can support game controllers without Bluetooth connectivity by using the aforementioned app as a Bluetooth relay for HID inputs. Thus, the SSE can enable game controllers without built-in Bluetooth or Wi-Fi to connect wirelessly to gaming systems. The phone or mobile device, connected to the game controller, acts as a bridge (e.g., by connecting to console via BLE), allowing wireless play that would otherwise be impossible due to the lack of updated hardware. In addition, the app can also serve as a relay to other third-party game controllers, whether or not they have Bluetooth/Wi-Fi connectivity capabilities, such as GameSir G8, for example, or Bluetooth controllers such as Xbox controllers or PlayStation DualSense controllers. This means that if a user prefers to use a specific game controller for a specific game or platform but does not have access to a way to connect that game controller to the same game/platform, when the preferred game controller is connected to the mobile device running the “app”, the “app” can use the SSE as a way to connect to the gaming platform, which also solves the third-party controller compatibility issues described below.

As long as the app is installed on the mobile device and can detect the third-party game controller that is connected (via API or firmware) to the console and/or paired or connected to a mobile device (e.g., via a wireless communication device), the SSE can be used on that mobile device. The following is an example configuration:

Initial Setup: Connect the game controller to the mobile smartphone via a physical connection (e.g., Lightning, USB-C, or wireless).

App Detection: Launch the “app” on the smartphone. The user can then enter the SSE settings screen and connect the game controller over Wi-Fi or Bluetooth to another device by turning on pairing functionality in the app, and by automatically detecting devices on the network that are available to pair with.

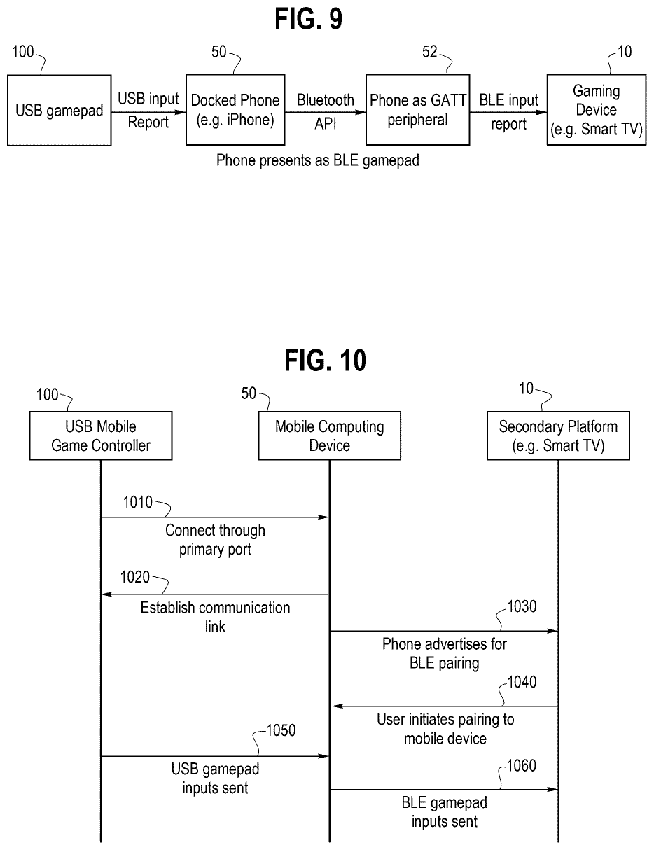

Bluetooth Relay Mechanism: FIG. 9 is a diagram illustrating a Bluetooth relay mechanism of an embodiment. As shown in FIG. 9, the USB gamepad (e.g. a game controller can be wired to the phone through the USB-C connector or any suitable electrical connector) provides a USB input report to a docked phone 50. A Bluetooth API allows the phone to act as a GATT peripheral 52 providing a BLE input report to the gaming device 10.

Bluetooth Activation: The app activates the smartphone's Bluetooth and enters a Bluetooth relay mode.

Signal Broadcasting: The app broadcasts the Bluetooth signal of the connected game controller on behalf of the game controller, advertising that the game controller is a peripheral device to pair with.

Device Pairing: On the target gaming device (e.g., PC, console), the user can navigate to Bluetooth settings and enable Bluetooth, and then select the game controller from the list of available devices to establish a connection.

FIG. 10 is a process flow diagram of an embodiment. As shown in FIG. 10, in this example, the game controller 100 connects to the mobile computing device 50 through a primary port (1010), after which the mobile computing device 50 establishes a communication link with the game controller 100 (1020). The mobile computing device 50 then advertises BLE pairing to the secondary platform 10 (1030), after which the user initiates pairing to the mobile device 50 (1040). The game controller 100 sends USB gamepad inputs to the mobile computing device 50 (1050), which sends BLE gamepad inputs to the secondary platform 10 (1060).

### HID Input Transmission:

Input Capture: The app captures HID inputs from the game controller via the physical connection.

Signal Relay: The app relays these inputs over Bluetooth to the target gaming device, simulating a direct Bluetooth connection

As noted above, this is a further solution to Problem 1 (Third-Party Controller Compatibility).

Generic Controller Support: The app is designed to also serve as a relay for other third-party controllers, such as the GameSir G8, Xbox controllers, or PlayStation DualSense controllers. For example, the user could pair via Bluetooth to the game controller app, and then use the game controller app to establish a connection to another host device. For these game controllers, the app captures Bluetooth inputs and relays them to the target gaming device, ensuring compatibility and a seamless wireless experience. The app can also enhance play further by operating as a display that accepts touch screen inputs, such as additional inputs that may not be existing on the third-party controller.

In certain embodiments, it may be beneficial to augment the inputs on the device. For example, if a user is playing a Steam game and the game controller does not have specialized button uses on a Steam controller, the app could render one for the user. As another example, when a PS5 game is being played, the app can provide a touch bar if the game controller does not have one. In this way, users have more complete functionality regardless of the exact characteristics of the input device. In certain embodiments, the app can also substitute for having a physical controller, enabling anyone to pair to various host devices via Bluetooth or Wi-Fi without having a game controller (e.g., if their game controller ran out of battery, or if they do not own one at all). While Google Stadia (discontinued), Netflix's Game Controller app for TVs, or Xbox Cloud Gaming touch screen user interface (UI) provide touch controllers, they are service specific and do not support Wi-Fi and Bluetooth combined functionality.

In other embodiments, the phone can be a window into game controller inputs, and various on-screen options can be presented to provide easy access to settings that would be otherwise impossible to adjust with the game controller alone (e.g., adjusting the button remapping or changing joystick/trigger dead zones).

Multiple Game Controllers: With reference again to FIG. 1C, multiple game controllers 100, 100A (e.g., from two different manufactures) can be connected to the mobile device 50 simultaneously (e.g., via Bluetooth or wired connection) enabling multiple stream input to pass to the host device 10 for multiplayer gameplay. The touch screen controller above could also be one or more of the controllers (e.g., by splitting the screen to show multiple touch controllers simultaneously on a single phone or showing them on separate phones) in this example.

In certain embodiments, dynamic island, push notifications, or their Android equivalents, as well as other out-of-app notifications, can inform users about the status of connected controllers when the app is sent to the background. If a third-party controller is connected but the connection cannot be maintained in the background, these mechanisms can notify the user accordingly.

Continued Usage of the Mobile Gaming Device: The user can continue to use their mobile device for independent uses (e.g., taking a call, sending a text message) without losing connection. The SSE handles this by leveraging the keep-alive method the app sends a signal to the mobile game controller to stay connected to the console. Other embodiments can allow a user to control aspects on other devices without losing a connection to the gaming device.

### Problem 3: Difficulty Connecting to TV Streaming Devices That Do Not Support Bluetooth or Wi-Fi

Playing games on TV streaming devices like Roku (e.g., a digital media player or platform) can be challenging, as many of these devices lack native Bluetooth support (or some other specific wireless communication technology). As a result, users are unable to connect game controllers via Bluetooth, limiting their ability to enjoy a seamless gaming experience. To address this problem, in some embodiments, the app can allow the game controller to maintain a persistent connection through an EA (External Accessory) session, even when the app is backgrounded. This is accomplished by implementing a Wi-Fi-based solution in the app, which allows connectivity to persist even when the app is in the background.

Wi-Fi Connection Persistence: The SSE mode uses the mobile app to establish and maintain a Wi-Fi connection between the game controller and the TV streaming device. This better ensures that the game controller remains connected and functional, even if the app is backgrounded, avoiding the issue where backgrounding the app disconnects the game controller.

Generic Controller Compatibility: The solution is designed to work with a plurality of different types of game controllers (e.g., game console specific and generic Bluetooth controllers). The app acts as a bridge, passing through inputs over Bluetooth and maintaining the connection over Wi-Fi.

Optimization for Persistent Connections: While backgrounding the app typically disconnects the game controller, this solution aims to optimize the connection persistence by potentially using live activities on iOS, or other app backgrounded functions. This could involve maintaining a lightweight service that keeps the Wi-Fi session active or using other technical strategies to ensure the controller stays connected.

### Examples of How to Accomplish a Persistent EA Session

### Wi-Fi Connection Establishment:

App Initialization: Upon entering SSE, the app utilizes device network hardware to initiate a Wi-Fi scan for a host streaming device, providing a UI that allows the user to initiate a connection. The UI responds to connection state, allowing the user to disconnect and return to normal Wi-Fi operation as desired.

Game Controller Connection: Using established host protocols for supported host streaming devices, the app acts as a game controller, allowing events, real or simulated, to be communicated across the Wi-Fi connection to the host device.

### Persistent Connection Management:

EA Session Maintenance: Once connected as an EA session, the game controller events are received by the service and propagated as virtual controller events across the Wi-Fi session to the host device as if the app was in the foreground in the same manner as events would be forwarded to the operating system for a controller of a natively installed game.

Service Implementation: The controller data service is abstracted from the app UI to allow it to run independently from the interface, allowing it to run even when the UI is in the background. U.S. patent application Ser. No. 18/202,755, which is hereby incorporated by reference, described embodiments that can be used with this embodiment.

### Generic Controller Compatibility:

Bluetooth Relay: The app itself mimics a game or similar application as it receives the events directly from the game controller. The app then acknowledges receipt and handling of these events to prevent the operating system (OS) from taking further action. Upon receipt, the events are mapped to virtual events and passed through the EA session connection to the host device to be re-interpreted as game commands.

Controller Pass-Through: Regardless of the source controller, virtual or physical, the events are mapped to a single output to be communicated to the host device. In this way, the app itself is the recognized game controller that interfaces with the remote device and application, allowing for one or more input devices to be the source of the events, with the only limitation of interface being that of the app and its underlying operating system.

### Problem 4: Friction and Discoverability Around Pairing

Pairing game controllers over Bluetooth (or some other specific wireless communication technology) with multiple devices can also be confusing. For example, connecting an Xbox controller to a phone or mobile device may require specific button configurations that are not easily discoverable, and switching back to a previously-paired device involves another complex input combination. Managing these connections can become cumbersome, detracting from the overall user experience. The complexity increases when using Wi-Fi for pairing, as different game controllers have their own pairing protocols and conventions. Additionally, many mobile game controllers also only offer one or the other method of wireless connection—either Bluetooth or Wi-Fi—but not both.

To address this problem, in some embodiments, the SSE leverages the mobile app to facilitate more seamless pairing interactions, simplifying the process of connecting the game controller to multiple devices. The app provides an intuitive interface for managing previously-paired devices, devices available to pair on the Wi-Fi network, and the ability to turn on pairing from the apps interface, reducing the complexity and improving user experience of pairing the game controller. The pairing process becomes more discoverable and user-friendly, ensuring a smoother experience when switching between devices.

By automatically surfacing devices on the network through the app, as well as any previously connected Bluetooth devices, the user can easily select which host device they want to connect to over Wi-Fi or Bluetooth.

### User Interface for Pairing:

Centralized Management: The app provides a centralized interface for managing all pairing interactions. Users can view and manage previously-paired devices, as well as initiate new pairings from a single screen. This is unique for mobile gaming controllers that may or may not have built-in Bluetooth functionality.

Visual Indicators: Clear visual indicators guide users through the pairing process, showing the status of connections and available devices.

### Automatic Surfacing of Devices:

Network Scanning: The app scans the local network to surface devices available for pairing over Wi-Fi. This includes consoles, PCs, and TV streaming devices (e.g., a Fire TV or Roku TV). This also means that the app can proactively suggest when the app is foregrounding new devices that may be ideal for playing with the game controller through push notifications, or in-app prompts. This can also be done in the background in certain embodiments, allowing for smart suggestions. For example, a prompt can appear when near an Apple TV device stating “connect to your Apple TV?”

Bluetooth Discovery: The app also performs Bluetooth pairing, allowing the user to initiate pairing and advertise to Bluetooth central devices that the app and connected game controller are available for pairing.

### Simplified Pairing Process:

Guided Pairing: Users are provided with step-by-step instructions to initiate and complete pairing. When a user wants to pair another device for the second screen experience, a screen appears to guide them through the process. The user can initiate pairing by pressing a button on the game controller. When the button is pressed, it sends a command to the firmware to initiate Bluetooth pairing. The user would then receive a popup to prompt them to pair to the device.

One-Click Reconnect: For previously-paired devices, users can reconnect with a single click, avoiding the need for complex input combinations or having to reinitiate the pairing process via the in-app user interface.

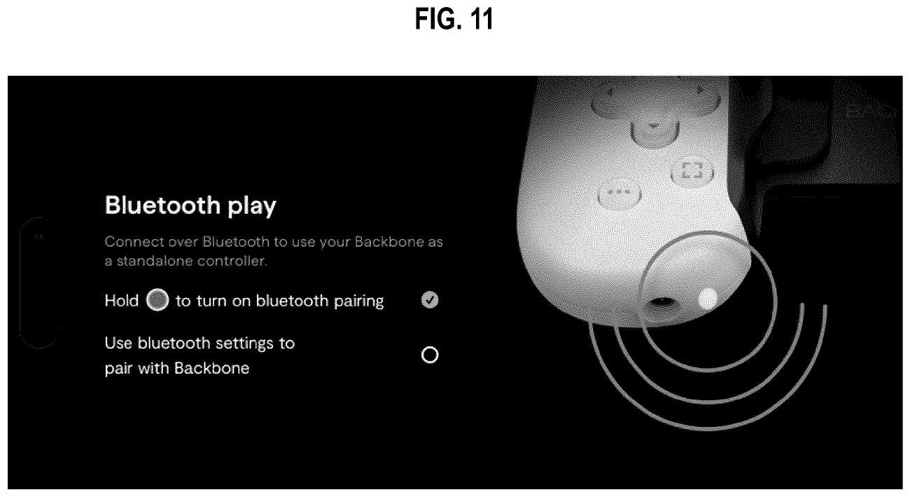

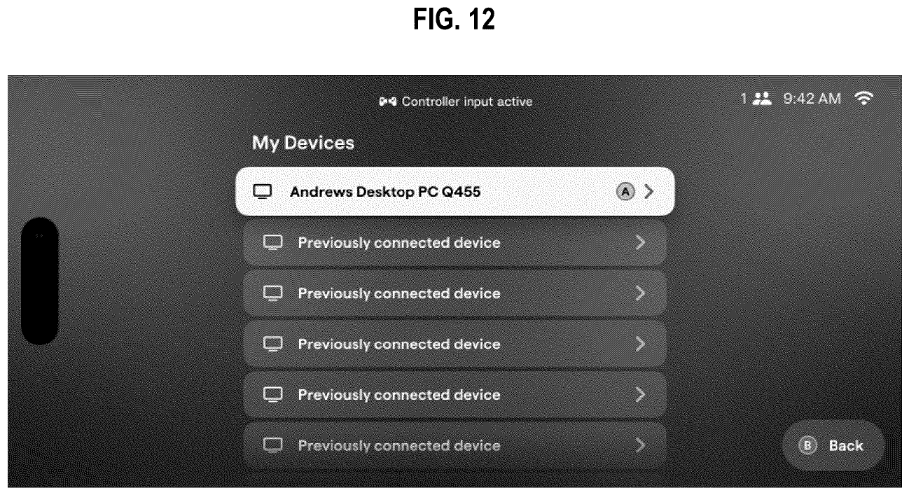

Because Bluetooth settings are saved on the mobile device (e.g., recently connected devices), a user could single tap a specific button (e.g., a platform button) and reinitiate pairing. A user can be notified of various pairing options in the app (see FIG. 12). Another embodiment allows a user to configure different button presses or actions with different consoles (e.g. users could program button inputs to map to specific pairing configurations). FIG. 11 is a screen shot showing an example guided pairing and single one-click connection

### Device Management:

Profile Storage: The app stores profiles of all paired devices, allowing users to easily switch between devices without needing to re-pair each time.

Connection Preferences: Users can set preferences for how devices should connect (e.g., prioritize Wi-Fi over Bluetooth) and save these settings for future use. FIG. 12 shows a screen shot of previous pairings.

### Pairing Protocol Support:

Multi-Protocol Handling: The app supports both Bluetooth and Wi-Fi pairing protocols, allowing users to choose the best method for their devices.

Protocol Bridging: For game controllers that only support one protocol, the app can bridge the connection, enabling seamless pairing regardless of the device's native capabilities.

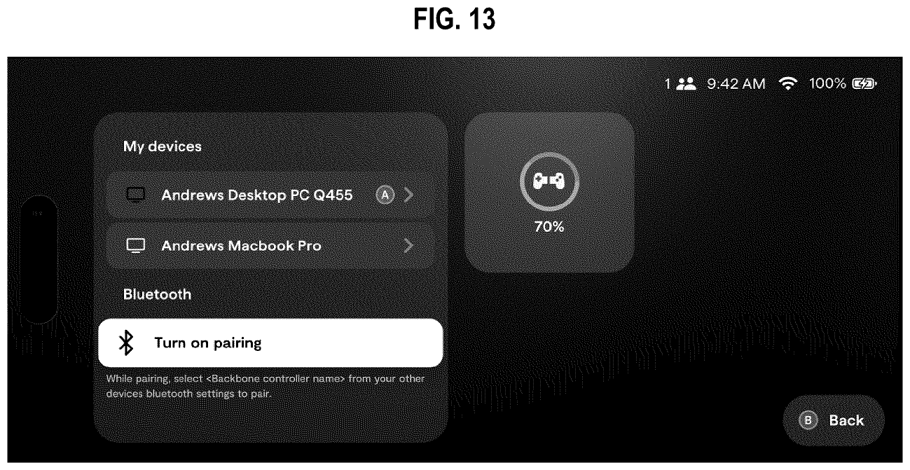

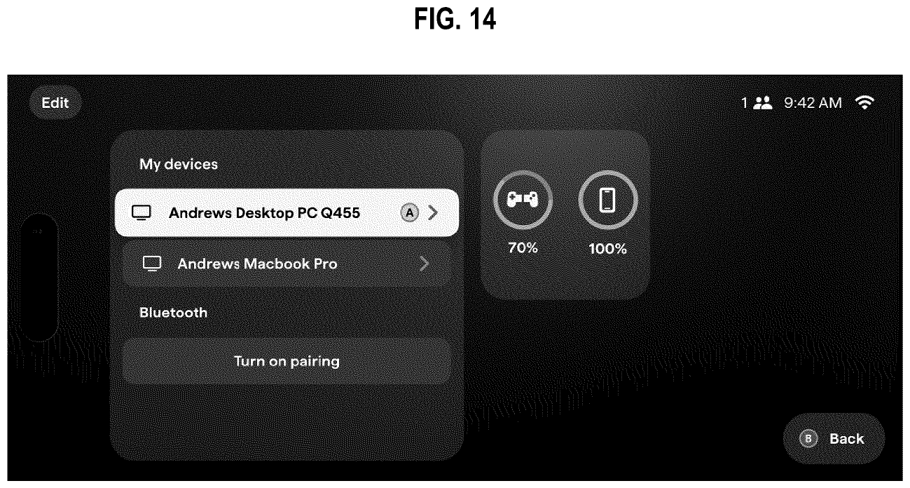

FIGS. 13 and 14 are screen shots showing the second screen experience handling multiple pairings and profiles, contextually surfacing game companion apps.

### Problem 5: Lack of Access to Game Companion App Integrations

Many games offer companion experiences through web platforms or mobile native apps, such as the Destiny 2 Companion app, which displays a user's character and inventory. However, these companion experiences often lack seamless integration with the main game or the game controller, creating friction in their discovery and use. As an example, while playing a game on a console, there may be a separate feature set available through a separate mobile app, like the Assassin's Creed Black Flag companion app that displays an in-game map. Yet without a direct connection between the user's console and mobile device, surfacing, accessing or discovering these features can be cumbersome. This can add friction in discovering and using these features, as players must manage separate devices and apps for a complete experience.

To address this issue, in some embodiments, the SSE uses the app to detect what game the user might be playing by monitoring HID (Human Interface Device) signals, including various inputs and outputs, such as audio data or control signals. This information allows the app to contextually surface the appropriate companion experiences in the second screen interface. The app could also utilize machine learning to process these signals, or other signals to help determine what game the user is playing. By analyzing gameplay patterns, user inputs, and other relevant data, the app can predict and present the more relevant companion experiences.

The following are examples of ways to monitor game usage to identify companion app integrations:

### HID Signal Detection:

Input Monitoring: The app monitors the inputs from the game controller for trends, frequently used inputs, or patterns, such as button presses, joystick movements, and other control signals through firmware and other middleware layers.

Output Monitoring: The app also monitors outputs from the gaming device for trends, such as audio cues or visual signals that can indicate specific game states or events. As an example, the app can monitor for key game events such as multiple objectives achieved and play a specialized audio queue or provide haptic feedback. Certain inputs and outputs may come from the platform operating service, and others may be manually configured.

### Contextual Surfacing:

Game Identification: Using the collected HID signals, the app identifies the game being played and retrieves relevant companion app features from the platform operating service (or manually configured features).

Interface Integration: The app integrates these features into the second screen interface, presenting them contextually based on the current game state.

### Data Collection and Analysis:

Gameplay Data: The app collects data on gameplay patterns, user interactions, and controller inputs.

Feature Extraction: Machine learning algorithms analyze this data to identify patterns and extract features that are indicative of specific games or game states. For example, if we train a model to detect menu button presses occurring in specific patterns, we might be able to determine the user is in the menu and adapt the functionality of the SSE accordingly (e.g., detecting that a user is opening the menu and then drilling down to a specific feature often can provide that specific feature as a widget in the second screen experience).

### Predictive Surfacing:

Real-time Analysis: The machine learning model analyzes incoming data in real time to predict the most relevant companion app experience to present to the user.

Dynamic Integration: The app dynamically integrates these companion experiences into the second screen interface, ensuring that the companion experiences are timely and contextually appropriate to what the user is playing and doing in the game.

### Additional Potential Gameplay Features:

Gameplay Features: By receiving controller and game signals via the various connections along with gameplay data received from APIs or other connections to the connected game, SSE could display custom game features to assist the user. For example, the ability to see a mini-map display on the app.

Capturing unique moments through game play: Leveraging game controller and game play signals, the SSE app could capture video or audio moments during intense or high gameplay through machine learning. For example, when a user finishes a difficult level, the app could capture the minutes before and after they complete the level. For other embodiments, the gaming device can capture the moments via API calls or the native video clip calls. FIG. 15 is a screenshot showing unique gameplay and apps in the second screen experience.

### Example Advantages

There are one or more advantages associated with pairing a game controller with a mobile computing device to provide a second screen experience. In general, at least some of the above embodiments can address the issues discussed above that revolve around the challenge of creating a more seamless, user-friendly, and universally-compatible gaming experience, thereby moving closer to the goal of being able to use a game controller with any game, anywhere. Further, by addressing the limitations of traditional game controllers and enhancing the overall gaming experience, a second screen experience can provide a more comprehensive solution that benefits users in one or more ways. For example, the ability to extend game controller capabilities, add wireless connectivity, contextually surface companion experiences, and provide a seamless pairing interface can significantly improve the flexibility, convenience, and enjoyment of gaming across various platforms and devices.

The following are descriptions of some potential advantages, including but not limited to:

### Extending Controller Capabilities/Multi-Platform Controller Compatibility

A second screen experience can enhance the functionality of multi-platform game controllers by leveraging the mobile computing device (e.g., smartphone) to provide additional inputs and outputs specific to the connected gaming device. This can help ensure that users can access platform-specific features, such as touchpad controls and haptic feedback, which are often missing in generic game controllers. Also, by dynamically adjusting the interface based on the game and device, a second screen experience can provide a tailored and optimized gaming experience across various platforms.

### Adding Wireless Connectivity/Bluetooth and Wi-Fi Relay Mechanisms

A second screen experience can use a mobile app to act as a Bluetooth relay for HID inputs, enabling game controllers without built-in Bluetooth or Wi-Fi to connect wirelessly to gaming systems. This extends the convenience and flexibility of wireless play to game controllers that are traditionally restricted to wired connections. By bridging the gap between the game controller and the gaming device, the mobile computing device (e.g., smartphone) can help facilitate seamless wireless connectivity, enhancing user mobility and reducing cable clutter.

### Enhancing the Gameplay Experience

A second screen experience can be used to provide contextually-surfacing companion experiences. The second screen experience can leverage HID signals and machine learning to detect the game being played and surface relevant companion app features in the second screen interface. This integration can help ensure that users have easy access to additional controls and features that enhance their gameplay. By presenting contextually-appropriate companion experiences, the second screen experience can minimize friction and maximize the utility of companion apps, providing a richer and more-immersive gaming experience.

A second screen experience can also surface system-level controls for the host device, such as volume and brightness adjustments, allowing users to manage these settings without interrupting their gameplay. This integration of “essential” controls into the second screen interface further streamlines the user experience.

### Providing a Dedicated Interface for Seamless Pairing

By using an intuitive pairing process, the second screen experience app can simplify the process of connecting game controllers to multiple devices by providing a centralized and intuitive interface for managing pairing interactions. Users can view and manage previously-paired devices, initiate new pairings, and switch between devices with ease. The app's visual indicators and guided pairing instructions can ensure that even complex configurations are straightforward and user-friendly.

The second screen experience app can also provide automatic device surfacing. The app can automatically scan the local network to surface devices available for pairing over Wi-Fi and performs Bluetooth discovery for nearby devices. This proactive approach enhances discoverability and reduces the effort required to connect game controllers to various gaming systems.

Further, the second screen experience app can be used for profile storage and connection preferences. The app can store profiles of all paired devices and allow users to set connection preferences, such as prioritizing Wi-Fi over Bluetooth. This feature can help ensure that users can quickly reconnect to their preferred devices without needing to reconfigure settings, streamlining the overall user experience.

### Example Game Controllers

As mentioned above, any suitable type of game controller can be used with these embodiments. The following paragraphs provide examples of various game controllers. It should be understood that these are merely examples and that other types of game controllers can be used.

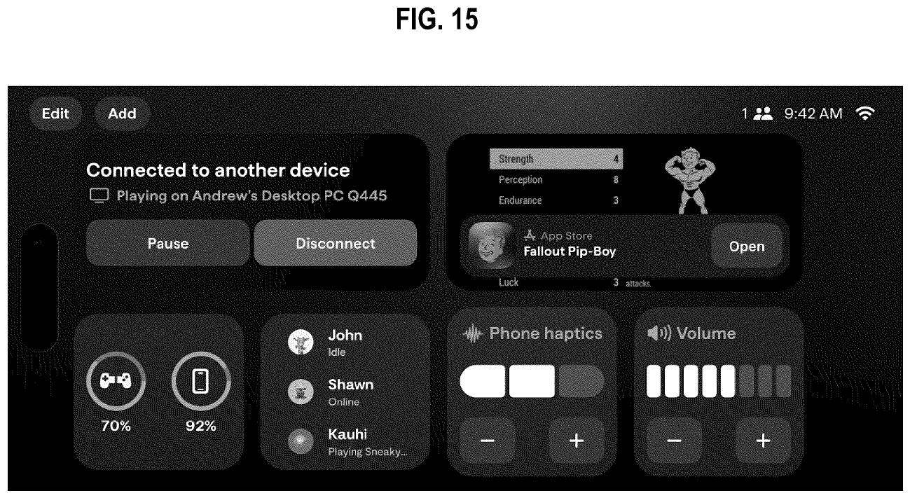

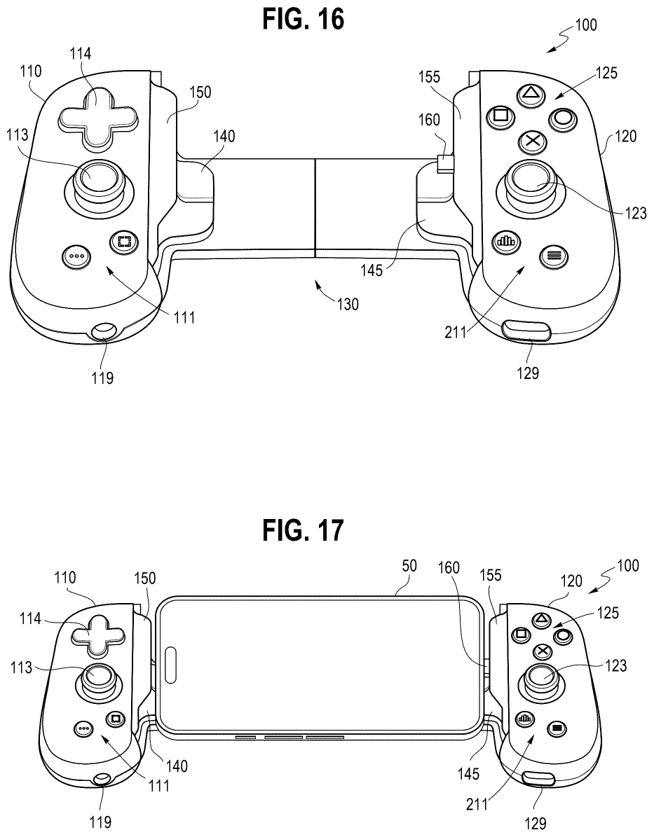

Turning again to the drawings, FIGS. 16-19 are illustrations of a handheld game controller 100 of an embodiment for use with a mobile computing device 50. The game controller 100 and the mobile computing device 50 can each comprise one or more processors and one or more non-transitory computer-readable media having program instructions stored therein that, when executed by the one or more processors, cause the one or more processors to perform various functions, such as, but not limited to, some or all of the functions described herein.

As shown in FIG. 16, the handheld game controller 100 of this embodiment comprises a first (left) handle 110, a second (right) handle 120, and a bridge 130 coupling the first and second handles 110, 120. The first and second handles 110, 120 comprise a plurality of user input devices (e.g., control surfaces) that a user can manipulate to provide input to a video game (or other application) being run by a computing device, such as the mobile device 50 (e.g., a mobile phone or tablet) or any connected device (e.g., using a wireless connection or a wired connection). In this example, the user input devices take the form of buttons 111, 211; joysticks 113, 123; a directional pad (D-pad) 114, four “face buttons” (e.g., A, B, X, Y buttons) 125; bumper (shoulder) buttons (e.g., L1, R1) buttons (not shown); trigger buttons (e.g., L2, R2) (not shown); and rear buttons (not shown). The user input devices can be made of any suitable material. For example, in one embodiment, the buttons 111, 112, 121, 122; D-pad 114, and four “face buttons” 125 are membrane buttons, which are quieter and have a softer press compared to traditional buttons. It should be noted that the user input devices shown in these figures are merely examples, that more or fewer user input devices can be used, and that different types of user input devices can be used (such as, but not limited to, a knob, a wheel, a slider, a dial, a touch-sensitive screen/pad, a microphone for audio input (e.g., to capture a voice command or sound), a camera for video input (e.g., to capture a hand or facial gesture), etc.).

The handheld game controller 100 of this embodiment comprises an electrical connector 160 (e.g., a USB-C connector) that is configured to physically connect with a corresponding electrical connector on a mobile device 50 to provide transfer of data and/or power (e.g., from a power source connected to port 129). As will be discussed below, in other embodiments, a wired connector is not used, and a wireless communication device is used to provide transfer of data and/or power between the game controller and mobile device. (The wireless communication device can, but does not have to be, part of a magnetic connector.) In yet other embodiments, both a wired connector and a wireless communication device are used, where the wired connector and the wireless communication device can be used for similar or different purposes.

In this embodiment, the game controller 100 comprises a port 119 for headphones and a port 129 configured to accept a cable, which can be used for one or more purposes. For example, the cable can be used to connect the game controller 100 to another device, such as, for example, a mobile computing device (e.g., a phone), a smart TV, a computer, a game console, etc., so that the game controller 100 can be used with that other device. As another example, the cable can be used to connect the game controller 100 to an electrical outlet or other power source (e.g., a portable battery) to charge the game controller's battery/batteries (if present) and/or to charge the mobile device 50. As will be explained in more detail below, the game controller can also comprise a magnetic connector, which can be used, at least in part, to provide power to charge the mobile device 50.

In one embodiment, the game controller 100 includes one or more batteries and supports pass-through charging (e.g., to charge the mobile device 50, or vice versa), and the game controller 100 may (through software or other ways) identify preferences for charging. That is, a parallel charging method can be used (i.e., where batteries in both the game controller 100 and mobile device 50 are charged in parallel), or a pass-through charging system can be used where some of the pass-through charging power is diverted to top off the battery in the game controller 100. If the average game session length is known, the parallel charging can create the feeling that the game controller 100 is battery-less (e.g., based on average session length, etc.). The wired connection to port 129 may be the preferred way to transfer power by default. The wired connection (e.g., a USB-C cable) could provide power to the game controller 100 to power the mobile device 50 with or without charging the game controller's battery, or it could provide power from the game controller's battery to the mobile device 50, or it could charge the game controller's battery. Optionally, the mobile device 50 itself could transfer power to charge the game controller's battery. Software may be used to prioritize different configurations at different intervals or balance power supply based on previously predetermined thresholds. Examples of various power management techniques can be found in U.S. patent application Ser. Nos. 18/369,000 and Ser. No. 18/369,025, both filed Sep. 15, 2023, which are hereby incorporated by reference. It should be noted that the power management techniques described in those applications are merely examples and are not required for use with these embodiments. Further, other types of power management techniques can be used.

In this embodiment, the first and second handles 110, 120 are in sliding engagement with the bridge 130. In one example implementation, first and second linear racks are coupled to the first and second handles 110, 120, respectively, and are in sliding engagement with the bridge 130. The first and second linear racks can be located partly in the first and second handles 110, 120, respectively, and partly in the bridge 130. A pinion can be in contact with the first and second linear racks and configured to rotate relative to the bridge 130 as the first and second linear racks are translated relative to the pinion. Of course, this is just an example, and other mechanisms are possible.

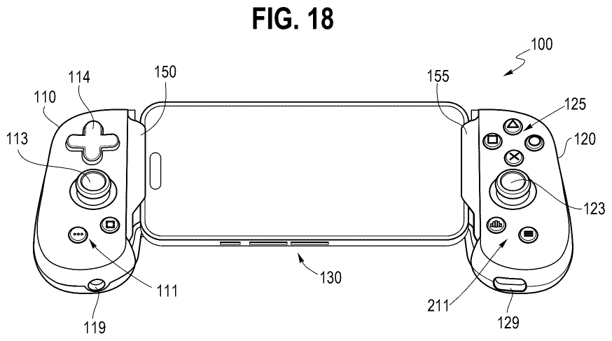

In operation, a user pulls the first and second handles 110, 120 apart from a default, compact position (in which the first and second handles 110, 120 have a minimum span between them) (as in FIG. 16) to create a span between the first and second handles 110, 120 that is longer than the length of the mobile device 50 (see FIG. 17). This position will sometimes be referred to herein as the extended position. This allows the mobile device 50 to be positioned between the first and second handles 110, 120. When in this position, the user can connect the electrical connector on the mobile device 50 with the electrical connector 160 on the handheld game controller 100. After the connection is made, the user allows the first and second handles 110, 120 to move together until the inside edges of the first and second handles 110, 120 contact the edges of the mobile device 50 to secure the mobile device 50 in place (see FIG. 18). This position will sometimes be referred to herein as the retracted position. In this example, the handheld game controller 100 comprises a spring or other mechanism to bias the first and second handles 110, 120 toward the retracted position. However, in other implementations, the user can be required to push the first and second handles 110, 120 toward the retracted position. Also, the handheld game controller 100 can comprise a stay-open and/or stay-closed latch mechanism to temporarily lock the first and second handles 110, 120 in various position(s). Also, instead of manually moving the first and second handles 110, 120, a user can interact with a physical actuator on the handheld game controller 100 (and/or a virtual actuator displayed on the mobile device 50) to cause movement of the first and second handles 110, 120.

The handheld game controller 100 in this embodiment comprises support pads 140, 145 and overhang portions 150, 155 to help secure the mobile device 50 when the game controller 100 is in the retracted position of FIG. 18. The support pads 140, 145 (which can be fixed to the handheld game controller 100 or removable) can be made from a compliant material to cushion and grip edges of a mobile device 50 placed between the first and second handles 110, 120. The support pads 140, 145 help to further secure the mobile device 50 in the “Y direction” (i.e., the direction perpendicular to and in the same plane as an axis (in the “X direction”) running between the first and second handles 110, 120). The overhang portions 117, 127 are configured to contact portions of the top surface of the mobile device 50 to help further secure the mobile device 50 in the “Z direction” (i.e., the direction upward and perpendicular to the X and Y directions). Examples of overhang portions and support pads can be found in U.S. patent application Ser. No. 18/777,919, filed Jul. 19, 2024, and U.S. patent application Ser. No. 18/805,902, filed Aug. 15, 2024, both of which are hereby incorporated by reference. It should be noted that the overhang portions and support pads described in those applications are merely examples and are not required for use with these embodiments. Other types of overhang portions and/or support pads can be used.

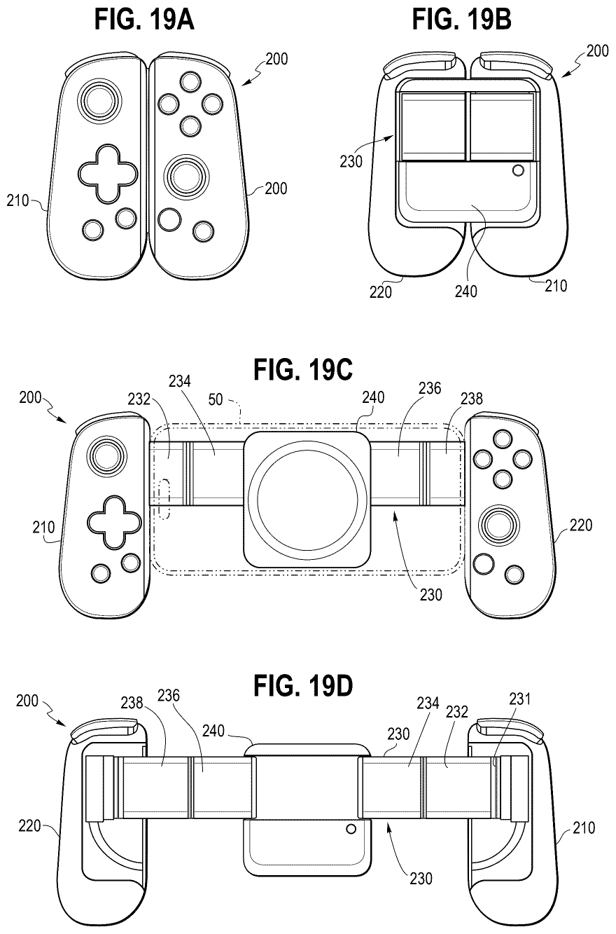

As mentioned above, while the game controller of some of the examples described herein have a bridge that allows the handles to pull away from each other in the X direction in a linear fashion, the first and second handles of the game controller can have different degrees of motion. For example, FIGS. 19A-19D illustrate a game controller 200 of an embodiment where the first and second handles 210, 220 and the bridge 230 are foldable. This design will sometimes be referred to herein as the “butterfly-yoke” design. The bridge 230 comprise a plurality of bridge segments 232, 234, 236, 238. In this example, the game controller 200 comprises a magnetic connector 240 (sometimes referred to herein as a “magnetic connector island”) that is part of the bridge 230. The use of a magnetic connector will be discussed in more detail below. Also, while a magnetic connector 240 is part of the bridge 230 in this example, in other implementations, the magnetic connector 240 is not present.

As shown in FIGS. 19A and 19B, the bridge 230 folds under the magnetic connector 240, resulting in a very compact shape. To use the game controller 200, a user would twist the handles 210, 220 outward and unfold the game controller 200 to extend the bridge 230 (see FIG. 19C), so the mobile device 50 can be placed on the magnetic connector 240.

As mentioned above, the folding embodiment shown in FIGS. 19A-19D is merely one example. Other mechanisms to move handles of a game controller, as well as different degrees and directions of motion (linear or non-linear) of the handles, are possible. Further, in other embodiments, non-movable “handles” (e.g., areas that can be gripped by a user but not necessarily “handle shaped”) can be integrated into the game controller. Also, the “bridge” does not imply that the first and second handles are slidable or otherwise movable with respect to each other, nor does the term “bridge” imply any specific configuration, unless such details are expressly recited in the claim.

As mentioned above, the game controller 200 in FIGS. 19A-19D contains a magnetic connector 240 in the game controller's bridge 240. A magnetic connector can be used in other configurations of the game controller, as the use of a magnetic connector is not limited to that of a foldable game controller. Examples of game controllers with magnetic connectors can be found in U.S. patent application Ser. No. 18/369,000 and Ser. No. 18/369,025, both filed Sep. 15, 2023, which are hereby incorporated by reference. It should be noted that the game controllers with magnetic connectors described in those applications are merely examples and are not required for use with these embodiments. Further, other types of game controllers and/or magnetic connectors can be used.

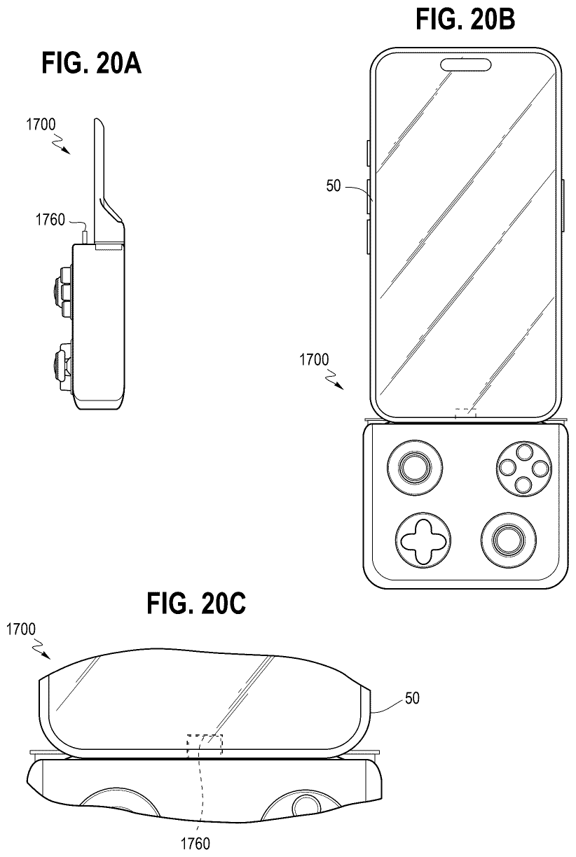

FIGS. 20A-20C illustrate another example game controller 1700. As shown in these drawings, this game controller 1700 has an electrical connector 1760 configured to couple with a corresponding port 1760′ in the mobile computing device 50. Unlike the game controllers illustrated in the other drawings presented herein, this game controller 1700 does not have movable handles. However, the left-and right-side areas of this game controller 1700 can be gripped by a user and may be referred to as “handles” even if these portions do not necessarily have a “handle shape.” Also, because the left-and right-side areas of this game controller 1700 are integrated into the game controller 1700, the game controller 1700 does not have a slidable bridge, as some of the game controllers described above do. However, the “bridge” in this embodiment can be considered the area of the game controller 1700 between the left-and right-side areas that are gripped by a user.

Again, the game controllers described above are merely examples, and other types of game controllers can be used. Further, while these example game controllers are configured to physically or magnetically couple with a mobile computing device, such that the game controller and the mobile computing device form an integrated device, in other examples, the game controller can be configured to be used as a stand-alone device that is separated from the mobile computing device (e.g., similar to a conventional game console controller).

### CONCLUSION

It is intended that the foregoing detailed description be understood as an illustration of selected forms that the invention can take and not as a definition of the invention. It is only the claims, including all equivalents, which are intended to define the scope of the claimed invention. Finally, it should be noted that any aspect of any of the embodiments described herein can be used alone or in combination with one another.

What is claimed is:

1. A method comprising:
performing in a mobile computing device in communication with a game controller and a game host, wherein the game host displays a game on a first display and wherein the mobile computing device comprises a second display:
determining an input that the game controller lacks to play the game; and
displaying, on the second display, the input that the game controller lacks to play the game.

2. The method of claim 1, wherein the input is displayed in a widget.

3. The method of claim 1, wherein the game controller further lacks an output used to play the game, and wherein the method further comprises using a component of the mobile computing device to provide the output that the game controller lacks.

4. The method of claim 1, wherein the game controller is not specifically designed for the game host, and wherein the method further comprises providing a gameplay feature that is not provided in a game controller that is specifically designed for the game host.

5. The method of claim 1, further comprising identifying the game host, wherein the determination of the input that the game controller lacks to play the game is based on the identification of the game host.

6. The method of claim 1, further comprising synchronizing transmission to the game host of a signal indicative of user manipulation of the input displayed on the second display.

7. A mobile computing device comprising:
a wired connector configured to communicate with a game controller that lacks an ability to wirelessly communicate with a game host;
a wireless communication device;
one or more processors; and
one or more non-transitory computer-readable media having program instructions stored therein that, when executed by the one or more processors, cause the one or more processors to:
receive, from the game controller via the wired connector, a signal indicative of a user input received via the game controller; and
relay the signal received from the game controller to the game host via the wireless communication device.

8. The mobile computing device of claim 7, wherein the program instructions, when executed by the one or more processors, further cause the one or more processors to:
receive, from a second game controller, a signal indicative of a user input received via the second controller; and
relay the signal received from the second game controller to the game host via the wireless communication device.

9. The mobile computing device of claim 7, wherein the program instructions, when executed by the one or more processors, further cause the one or more processors to:
determine an input that the game controller lacks to play a game; and
display, on a display of the mobile computing device, the input that the game controller lacks.

10. The mobile computing device of claim 7, wherein the program instructions, when executed by the one or more processors, further cause the one or more processors to:
determine an output that the game controller lacks to play a game; and
cause a component of the mobile computing device to provide the output that the game controller lacks.

11. A method comprising:
performing in a mobile computing device in communication with a game controller, wherein a game host does not support a wireless connection with the game controller:
receiving, from the game controller, a signal indicative of a user input received via the game controller; and
wirelessly relaying the signal received from the game controller to the game host.

12. The method of claim 11, wherein the method is performed by an application running on the mobile computing device, and wherein the mobile computing device and game controller remain connected even when the application is backgrounded.

13. The method of claim 11, further comprising maintaining a persistent wireless connection through an external accessory session.

14. A mobile computing device comprising:
one or more processors; and
one or more non-transitory computer-readable media having program instructions stored therein that, when executed by the one or more processors, cause the one or more processors to:
display, on a display of the mobile computing device, a plurality of previously-paired game hosts for user selection;
receive a user selection of one of the plurality of previously-paired game hosts; and
pair a game controller with the one of the plurality of previously-paired game hosts.

15. The mobile computing device of claim 14, wherein the program instructions, when executed by the one or more processors, further cause the one or more processors to provide a guided pairing process.

16. The mobile computing device of claim 14, wherein the program instructions, when executed by the one or more processors, further cause the one or more processors to provide a one-click reconnect process.

17. A method comprising:
performing in a mobile computing device in communication with a game controller used to play a game on a game host:
determining the game being played on the game host;
retrieving a companion application for the game; and
executing the companion application.

18. The method of claim 17, further comprising providing input received via the companion application to the game when contextually appropriate based on a current state of the game.

19. The method of claim 17, wherein the game is determined based on inputs received from the game controller.

20. The method of claim 17, wherein the game is determined based on outputs received from the game host.
